(19) United States
(12) Patent Application Publication
(10) Pub. No.: US 2011/0130852 A1
(43) Pub. Date: Jun. 2, 2011

(54) Method for selecting media files

(75) Inventor: Ola Thörn, Malmo (SE)

(73) Assignee: Sony Ericsson Mobile Communications AB, Lund (SE)

(21) Appl. No.: 12/592,552

(22) Filed: Nov. 27, 2009

(51) Int. Cl. G06F 17/00

(52) U.S. Cl. 700/94

(57) ABSTRACT

A method for selecting media files to be played back by a mobile device when traveling along a route and a method for selecting a media file to be played back by a battery-powered mobile device are described. Furthermore, a mobile device utilizing the aforementioned methods is described.

### BACKGROUND OF THE INVENTION

The present invention relates to a method for selecting media files to be played back by a mobile device when travelling along a route and a method for selecting a media file to be played back by a battery-powered mobile device. Furthermore, the present invention relates to a mobile device utilizing the aforementioned methods.

### BRIEF SUMMARY OF THE INVENTION

According to an embodiment, a method for selecting media files to be played back by a mobile device when traveling along a route is provided. According to the method, a traveling time for traveling along the route is automatically estimated in advance. Furthermore, at least one group of media files is automatically determined. Each group of the at least one group of media files comprises at least one media file from a plurality of media files and provides a total playing time of the media files of the group which corresponds approximately to the estimated traveling time. Then, the determined at least one group of media files is displayed to a user of the mobile device and a user selection of one of the at least one groups is detected.

When people are traveling, they enjoy consuming media, for example music or videos. By using a mobile device, for example a mobile phone, it is possible to consume media at any time and any place, especially during a journey or a trip. When consuming media on a trip, it may happen that a user is listening to for example an audio book and the trip ends before the end of the audio book. Thus the user cannot listen to the end. The same applies if a user is watching a movie and reaches a destination before the end of the movie. Furthermore, it may happen that a movie or an audio book finishes before the user reaches the destination. In these cases, the user may be dissatisfied as the user cannot listen until the end of the audio book or movie or the user will not be entertained by the media until the end of the trip. According to the above-described embodiment, the traveling time is estimated in advance and one or more groups of media files are determined which provide a total playing time which corresponds approximately to the estimated traveling time. The such determined groups of media files are presented for a selection to the user at the beginning of the trip. The user may select one of the presented groups and the total playing time of the selected group will approximately fit to the estimated traveling time. Thus, the user will be entertained during the trip and will reach the end of the played back media by the end of the trip.

According to an embodiment, for estimating automatically the traveling time of the route, the route from a user-defined starting point to a user-defined destination is determined using an electronic map and a routing functionality. Estimating the traveling time is based on the determined route and a user-defined transportation means. When the mobile device comprises for example a global positioning system (GPS) and a routing functionality for calculating automatically a route from the user-defined starting point to the user-defined destination, the required traveling time can be automatically estimated based on the determined route and the user-defined transportation means, for example traveling by car or by train.

According to another embodiment, the traveling time from a user-defined starting point to a user-defined destination is estimated by using predefined traveling time information based on historical traveling time information. If, for example, a user commutes five days per week from the user's home to the user's working premises, the mobile device may log the required traveling time and can therefore estimate the traveling time from the user's home to the working premises based on this historical traveling time information.

For determining automatically at least one group of media files, a media file may be separated into several separate media files, and a group comprising a plurality of the separate media files may be determined such that a total playing time of the plurality of separate media files corresponds approximately to the determined traveling time. For example, an audio or video media file, for example news, comprises several stories, video clips or sections. Such a media file may be separated automatically into several separate media files, for example several stories or video clips, and may be recombined such that a total playing time of the recombined files corresponds approximately to the determined traveling time.

Furthermore, at least one group of the at least one group of media files may comprise at least one media file comprising information geographically related to the route.

According to another embodiment, a media file of the plurality of media files comprises spoken text. Such a media file may comprise an audio book. For determining automatically at the least one group of media files, the text of the spoken text media file is automatically summarized such that a total playing time of the media files of the group of media files containing the spoken text media file corresponds approximately to the determined traveling time. In this way, the length of a media file containing spoken text can be adapted automatically to the traveling time.

The media files of the selected group of media files may be downloaded via a data communication at least partly in advance depending on a data communication performance along the route. By downloading the media files of the selected group of media files at least partly in advance, interruptions or dropouts during a playback of the media file due to data communication problems in areas with low bandwidth or bad coverage can be avoided.

A media file of the plurality of media files may comprise an audio book file, a movie video file, a music audio file, a news audio file, or a news video file. Furthermore, a media file may comprise any other kind of media, e.g. a talk show, a YouTube clip or a radio show.

According to an embodiment, a mobile device is provided. The mobile device comprises a processing unit having access to a plurality of media files. The processing unit is adapted to estimate in advance a traveling time for traveling along a predefined route, and to determine at least one group of media files. Each group of the at least one group of media files comprises at least one media file from the plurality of media files and provides a total playing time of the media files of the group which corresponds approximately to the estimated traveling time.

The mobile device may comprise a mobile phone, a personal digital assistant, a mobile navigation system, a mobile media player or a mobile computer.

According to another embodiment, a method for selecting a media file to be played back by a battery-powered mobile device is provided. According to the method, a remaining battery running time is automatically estimated and at least one media file from a plurality of media files is automatically determined, which provides a total playing time equal to or less than the remaining battery running time. The determined at least one media file is displayed to a user of the mobile device, and a user selection selecting one of the at least one media file is detected.

It is highly unwanted if a user watches a movie or listens to an audio file on the mobile device and the battery runs out of power before the movie or the audio file has finished. By estimating automatically a remaining battery running time and presenting a user those media files which can be played back within the remaining battery running time, it can be reliably avoided that the battery is running out of power before the media is completely played back.

According to a further embodiment, a mobile device comprises a battery for powering the mobile device and a processing unit having access to a plurality of media files. The processing unit is adapted to estimate a remaining battery running time, and to determine at least one media file from the plurality of media files which provides a total playing time equal to or less than the remaining battery running time.

The mobile device may be a mobile phone, a personal digital assistant, a mobile navigation system, a mobile media player or a mobile computer.

According to another embodiment, a method for selecting a media file to be played back by a battery-powered mobile device is provided. According to the method, a plurality of media files is displayed to a user of the mobile device, and a user selection selecting one media file of the plurality of media files is detected. Then, a total playing time of the selected media file is automatically determined and a remaining battery running time is automatically estimated. If the remaining battery running time is less than the total running time of the selected media file, an information indicating that the selected media file may not be played back completely is output to the user. By this, a user of the mobile device gets right at the beginning of playing back a media file a warning that it may not possible to play back the media file completely due to the current battery state.

According to an embodiment, for estimating automatically the remaining battery running time, at least one energy consuming characteristic for playing back the selected media file is automatically determined, and a remaining battery running time is automatically estimated depending on the at least one determined energy consuming characteristic. The energy consuming characteristic may be a loudness level, a lightness level, or a digital coding scheme of a content of the media file. By considering energy consuming playback characteristics of the selected media file, the energy needed for playing back the media file can be estimated very precisely and therefore the remaining battery running time can be estimated also very precisely.

According to a further embodiment, a mobile device is provided comprising a battery for powering the mobile device, a user interface, and a processing unit. The processing unit has access to a plurality of media files and is adapted to display the plurality of media files on the user interface of the mobile device, and to detect via the user interface a user selection selecting one media file of the plurality of media files. Furthermore, the processing unit is adapted to determine the total playing time of the selected media file, and to estimate a remaining battery running time of the battery. If the remaining battery running time is less than the total playing time of the selected media file, the processing unit outputs information via the user interface indicating that the selected media file may not be played back completely.

The mobile device may be a mobile phone, a personal digital assistant, a mobile navigation system, a mobile media player, or a mobile computer.

Although specific features described in the above summary and the following detailed description are described in connection with specific embodiment, it is to be understood that the features of the embodiments described can be combined with each other unless it is noted otherwise.

### BRIEF DESCRIPTION OF THE SEVERAL VIEWS OF THE DRAWING

Hereinafter, exemplary embodiments of the invention will be described with reference to the drawing.

The only FIGURE shows a mobile device according to an embodiment of the present invention.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

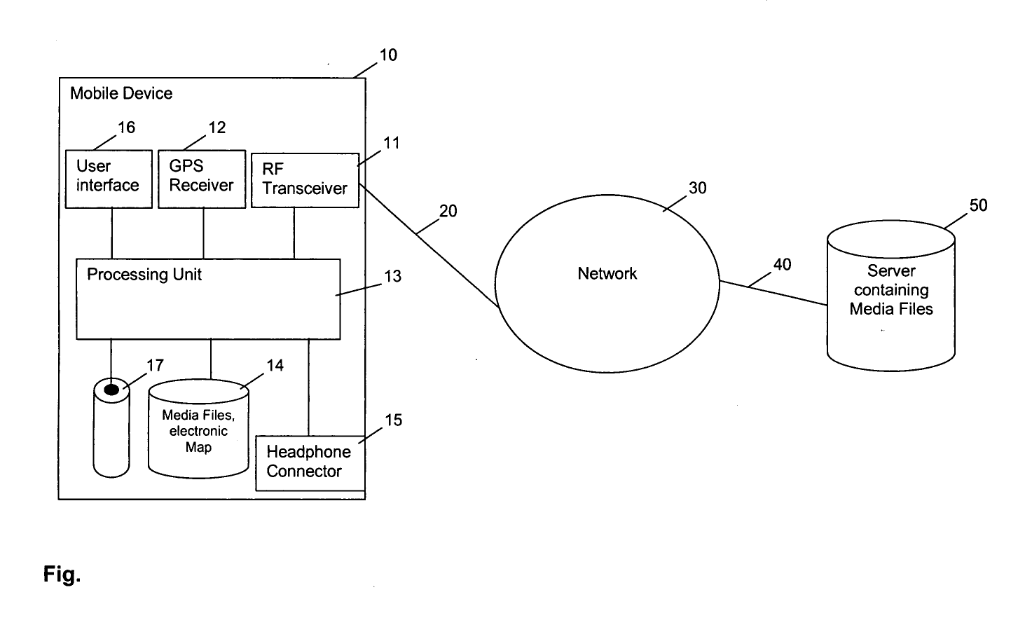

FIG. 1 shows schematically a mobile device 10 which may be connected to a server 50 via a network 30. A connection 20 between the mobile device 10 and the network 30 may be a wireless connection, for example a GSM, UMTS, GPRS or a Bluetooth connection. However, connection 20 may be any other kind of wireless or wired connection. Connection 40 between the network 30 and the server 50 may also be any kind of wireless or wired connection.

The mobile device 10 comprises a radio frequency transceiver 11, a GPS receiver 12, a processing unit 13, a memory 14, a headphone connector 15, a user interface 16 comprising for example a keypad and a display, and a battery 17. Additionally, the mobile device 10 may comprise additional components, for example a loudspeaker, a microphone etc., but these components are not shown in the figure to simplify matters. The processing unit 13 is connected to the radio frequency transceiver 11, the GPS receiver 12, the headphone connector 15, the memory 14 and the user interface 16. The processing unit 13 and other components of the mobile device 10 are powered by the battery 17, which may be a rechargeable battery. The GPS receiver 12 may receive signals from a global positioning system, for example GPS or Galileo, to provide a positioning information of the mobile device 10. The radio frequency transceiver 11 may utilize a data communication between the processing unit 13 and the server 50 via a wireless connection 20 and a data communication network 30. The memory 14 may be used to store a plurality of media files which may be played back by the processing unit 13 as audio data which may be output via the headphone connector 15 or as video data which may be output on a display of the user interface 16. Furthermore, the memory 14 may be used for storing an electronic map.

Operation of the processing unit 13 will now be described in more detail in connection with several user scenarios and by referencing the figure.

When a user of the mobile device 10 is planning to travel from a starting point to a destination, the user may want to playback audio or video media during traveling for entertainment. When consuming media during traveling, the following problems may arise:
The user is for example listening to an audio book or watches a movie and reaches the destination before the audio book or movie has finished and must therefore interrupt listening to the audio book or watching the movie.
The user is consuming media, for example an audio book, a movie or news, and the media finishes before the user reaches the destination.
The user is consuming media and suddenly the battery of the mobile device runs out of energy and thus the user cannot listen or watch the media until the end.

In order to avoid the above-described unwanted situations, the processing unit 13 of the mobile device 10 estimates in advance a traveling time for traveling along a planned route. The traveling time may be estimated by a routing functionality which may be provided in the mobile device to guide the user in connection with the GPS receiver 12 from the starting point to the destination. By providing the mobile device 10 with information concerning the traveling means to be used, for example by providing the users intention to travel by foot, by car or public transportation, the traveling time for the planned route can be estimated. As an alternative, the traveling time can be estimated from historical data which has been recorded during a previous travel from the starting point to the destination. Historical data may be used especially in case of travels which are conducted regularly, for example when the user is commuting five days per week from home to a working place. The historical data may further provide different traveling times depending on traffic data or the time of day the user leaves for the travel, thus accounting for a rush hour.

Based on the estimated traveling time, the mobile device 10 presents on the user interface 16 a list of available media files which may be played back during the travel. The media files may be stored locally in the memory 14 of the mobile device 10 or may be accessible via the network 30 at a network server 50. One entry of the list of media files may comprise a single media file having a length fitting approximately to the estimated traveling time, or may comprise several media files having in sum approximately a total playing time fitting to the estimated traveling time. In case several versions of a media file, for example of a movie or an audio book, are available, the processing unit may choose a shorter or longer version depending on the estimated traveling time. A longer version of a movie may for example comprise a director's cut, a shorter version of a movie may comprise a movie wherein some scenes have been removed. The media file may comprise news comprising several separate clips and the processing unit may divide the news media into the several clips and recombine some of the several clips to gain a total playing time fitting to the estimated traveling time. Selecting the news media file may be based on regional aspects preferably including clips dealing with information of the area the user is traveling along, or may be based on an importance or novelty of a news clip. In case the media file comprises an audio book which is based on a text and presented to the user by a “text to speech” conversion, the reading speed may be speeded up or down to achieve a total reading time fitting approximately to the estimated traveling time. The reading speed may be adapted additionally to information from a traffic channel indicating that the traveling time may be extended or may be shortened. Furthermore, the text may be summarized to shorten the audio playback of the text or some additional information may be added to extend the playback time of the text.

Furthermore, the media files may be selected from user-defined or pre-defined playlists or collections stored in the mobile device 10. A user-defined playlist may comprise any kind of the media the user prefers to listen to. The pre-defined playlists may be defined automatically based on the users preferences.

In case the media is retrieved during the travel from the data server 50 via the communication network 30, the processing unit 13 may stream some parts of the media data in advance and store these media data intermediately in the memory 14 to guarantee an undisturbed playback in case the communication between the mobile device 10 and the server 50 may be deteriorated during the travel due to areas with low bandwidth and bad coverage, for example in a tunnel or in city canyons.

Furthermore, the processing unit 13 of the mobile device 10 determines the remaining energy stored in the battery of the mobile device 10. Based on the remaining energy stored in the battery 17 and a required energy for playing back a media file, the processing unit 13 may determine if a media file can be completely played back before the battery 17 runs out of energy. Therefore, the processing unit 13 may list on the user interface only those media files which can be played back completely or may mark those media files which may not be played back completely with an information indicating that these media files may not be played back completely due to the remaining energy stored in the battery 17. Each media file may provide additional information concerning for example a lightness or a sound activity to enhance the estimation on how much power is required for playing back the media file. The amount of lightness affects power needed for the display, as black areas consume less power than white areas. A media having a low sound level or longer intervals with no sound requires fewer energy for playing back the sound than media with continuous high volume sound. This information concerning the lightness and sound may be analyzed in advance and stored together with the media file, or may be analyzed by the processing unit 13 on demand. Furthermore, for estimating the required energy for playing back a media file, the processing unit 13 may take into account if the media file is played back from the local memory 14 or has to be streamed from the server 50. In case the media can be played back from the local memory 14, the radio frequency transceiver 11 may be switched off or may be operated in a low power mode to save energy. Furthermore, it may be considered to stream the media from the server 50 at a lower bit rate to save energy.

Finally, the processing unit 13 displays a list of the media files filtered according to the above description on the user interface 16 and the user selects a desired media file or a desired group of media files for playback.

While exemplary embodiments have been described above, various modifications may be implemented in other embodiments. For example, the list of media files presented to the user may be compiled irrespective of the remaining battery energy. Then, when the user selects one of the media files or a group of the media files, remaining battery running time is automatically estimated and compared with a total playing time of the selected media file or media files. In case the total playing time is longer than the remaining battery running time, an information may be output to the user indicating that playing back the selected media file may not be possible completely due to the current battery energy state. Then, the user may change the selection, may recharge the battery, or may accept this restriction and playback the media file anyway.

Finally, it is to be understood that all the embodiments described above are considered to be comprised by the present invention as it is defined by the appended claims.

What is claimed is:

1. A method for selecting media files to be played back by a mobile device when traveling along a route, comprising:
estimating automatically in advance a traveling time for traveling along the route,
determining automatically at least one group of media files, wherein each group of the at least one group of media files comprises at least one media file from a plurality of media files and provides a total playing time of the media files of the group which corresponds approximately to the estimated traveling time,
displaying the determined at least one group of media files to a user of the mobile device, and
detecting a user selection selecting one of the at least one group.

2. The method according to claim 1, wherein estimating automatically a traveling time of the route comprises:
determining the route from a user defined starting point to a user defined destination using an electronic map and a routing functionality, and
estimating the traveling time based on the determined route and a user defined transportation means.

3. The method according to claim 1, wherein estimating automatically a traveling time of the route comprises:
estimating the traveling time from a user defined starting point to a user defined destination using predefined traveling time information based on historical traveling time information.

4. The method according to claim 1, wherein determining automatically at least one group of media files comprises separating a media file into several separate media files, and determining a group comprising some of the separate media files such that a total playing time of the some separate media files corresponds approximately to the determined traveling time.

5. The method according to claim 1, wherein determining automatically at least one group of media files comprises defining for at least one of the media files parts to be skipped during the playback of the media file such that a total playing time of the group of media files corresponds approximately to the determined traveling time.

6. The method according to claim 1, wherein at least one group of the at least one group of media files comprises at least one media file comprising information geographically related to the route.

7. The method according to claim 1,
wherein a media file of the plurality of media files comprises spoken text, and
wherein determining automatically at least one group of media files comprises automatically summarizing the text of the spoken text media file such that a total playing time of the media files of the group of media files containing the spoken text media file corresponds approximately to the determined traveling time.

8. The method according to claim 1, further comprising:
downloading via a data communication the media files of the selected group of media files at least partly in advance depending on a data communication performance along the route.

9. The method according to claim 1, wherein a media file of the plurality of media files comprises at least one of an audio book file, a movie video file, a music audio file, a news audio file, and a news video file.

10. A mobile device comprising a processing unit having access to a plurality of media files, wherein the processing unit is adapted to:
estimate in advance a traveling time for traveling along a predefined route, and
determine at least one group of media files, wherein each group of the at least one group of media files comprises at least one media file from the plurality of media files and provides a total playing time of the media files of the group which corresponds approximately to the estimated traveling time.

11. The mobile device according to claim 10, wherein the mobile device comprises a device selected from the group comprising a mobile phone, a personal digital assistant, a mobile navigation system, a mobile media player, and a mobile computer.

12. A method for selecting a media file to be played back by a battery powered mobile device, comprising:
estimating automatically a remaining battery running time,
determining automatically at least one media file from a plurality of media files which provides a total playing time equal to or less than the remaining battery running time,
displaying the determined at least one media file to a user of the mobile device, and
detecting a user selection selecting one of the at least one media file.

13. A mobile device comprising a battery for powering the mobile device and a processing unit having access to a plurality of media files, wherein the processing unit is adapted to:
estimate a remaining battery running time, and
determine at least one media file from the plurality of media files which provides a total playing time equal to or less than the remaining battery running time.

14. The mobile device according to claim 13, wherein the mobile device comprises a device selected from the group comprising a mobile phone, a personal digital assistant, a mobile navigation system, a mobile media player, and a mobile computer.

15. A method for selecting a media file to be played back by a battery powered mobile device, comprising:
displaying a plurality of media files to a user of the mobile device,
detecting a user selection selecting one media file of the plurality of media files,
determining automatically a total playing time of the selected media file,
estimating automatically a remaining battery running time, and
if the remaining battery running time is less than the total playing time of the selected media file: outputting information indicating that the selected media file may not be played back completely.

16. The method according to claim 15, wherein the step of estimating automatically a remaining battery running time comprises:
determining automatically at least one energy consuming characteristic of a playback of the selected media file, and
estimating automatically a remaining battery running time depending on the at least one determined energy consuming characteristic.

17. The method according to claim 16, wherein the energy consuming characteristic comprises at least one of a loudness level, a lightness level, and a digital coding scheme of a content of the media file.

18. A mobile device comprising a battery for powering the mobile device, a user interface, and a processing unit having access to a plurality of media files, wherein the processing unit is adapted to:
display the plurality of media files on the user interface of the mobile device,
detect via the user interface a user selection selecting one media file of the plurality of media files, determine a total playing time of the selected media file,
estimate a remaining battery running time of the battery, and,
if the remaining battery running time is less than the total playing time of the selected media file, output information via the user interface indicating that the selected media file may not be played back completely.

19. The mobile device according to claim 18, wherein the mobile device comprises a device selected from the group comprising a mobile phone, a personal digital assistant, a mobile navigation system, a mobile media player, and a mobile computer.
